(19) United States
(12) Patent Application Publication
(10) Pub. No.: US 2022/0274046 A1
(43) Pub. Date: Sep. 1, 2022

(54) INTEGRATION OF PLASMA AND HYDROGEN PROCESS WITH COMBINED CYCLE POWER PLANT, SIMPLE CYCLE POWER PLANT AND STEAM METHANE REFORMERS

(71) Applicant: Monolith Materials, Inc., Lincoln, NE (US)

(72) Inventors: Peter L. Johnson, Mountain View, CA (US); Robert J. Hanson, Lincoln, NE (US); Roscoe W. Taylor, Kingwood, TX (US)

(21) Appl. No.: 17/498,693

(22) Filed: Oct. 11, 2021

Related U.S. Application Data
(63) Continuation of application No. 14/591,528, filed on Jan. 7, 2015, now abandoned.
(60) Provisional application No. 61/933,494, filed on Jan. 30, 2014.

(51) Int. Cl. B01D 53/047; C01B 3/56; C01B 3/24; F02C 3/22; F01K 23/10

(52) U.S. Cl. CPC B01D 53/047; C01B 3/56; C01B 3/24; F02C 3/22; F01K 23/10; B01D 2257/108; C01B 2203/0266; C01B 2203/0861; C01B 2203/043; C01B 2203/1241; Y02E 20/16; B01D 2257/102; B01D 2257/7022; B01D 2257/408; B01D 2257/502; B01D 2257/7025; B01D 2256/16; Y02C 20/20; Y02P 20/156

(57) ABSTRACT

The integration of plasma processes with combined cycle power plant, simple cycle power plant, and steam reforming processes. A method of producing purified hydrogen gas and fuel is described including compressing a feed stream of hydrogen, adding tail gas from a plasma process to the feed stream, passing the tail gas modified feed stream into a pressure swing adsorption system generating a purified hydrogen product and a pressure swing adsorption tail gas, separating and compressing the purified hydrogen product, and separating and compressing the pressure swing adsorption tail gas for use as fuel. A method of generating and recapturing electricity from a single or combined cycle power plant is also described including flowing natural gas into a plasma process and hydrogen generating plant, flowing the hydrogen produced into the power plant, flowing natural gas into the power plant, resulting in the production of electricity. The electricity is flowed back into the plasma process plant, and in the case of the combined cycle power plant the electricity is partially flowed into a power grid as well. A method of generating and recapturing electricity from a steam power plant is also described, including inputting electricity and natural gas into a plasma process air and hydrogen generating plant, flowing the air and hydrogen produced into a steam generating boiler, flowing the steam generated into a steam power plant, resulting in the production of electricity which is flowed back into the plasma process plant.

### CROSS-REFERENCE TO RELATED APPLICATIONS

This application is a continuation of U.S. application Ser. No. 14/591,528 filed Jan. 7, 2015, which claims the benefit under 35 U.S.C. § 119(e) of U.S. Provisional Application No. 61/933,494 filed Jan. 30, 2014, the disclosures of which are expressly incorporated by reference herein in their entirety.

### TECHNICAL FIELD

The field of art to which this invention generally pertains is methods and apparatus for making use of electrical energy to effect chemical changes.

### BACKGROUND

No matter how unique the product or process, over time, all manufacturing processes look for ways to become more efficient and more effective. This can take the form of raw material costs, energy costs, or simple improvement in process efficiencies, among other things. In general, raw material costs and energy resources, which are a substantial part of the cost of most if not all manufacturing processes, tend to actually increase over time, because of scale up and increased volumes, if for no other reasons. For these, and other reasons, there is a constant search in this area for ways to not only improve the products being produced, but to also produce them in more efficient and effective ways with lower overall environmental impact.

The systems described herein meet the challenges described above while accomplishing additional advances as well.

### BRIEF SUMMARY

A method of producing purified hydrogen gas and fuel is described including passing tail gas from a plasma process into a pressure swing adsorption system generating a purified hydrogen product and a pressure swing adsorption tail gas, separating and compressing the purified hydrogen product, and separating and compressing the pressure swing adsorption tail gas for use as fuel, or reuse back into the plasma process.

Additional embodiments include: the method described above including mixing the tail gas from a plasma process with a feed stream from a steam methane reformer prior to passing the combined tail gas into a pressure swing adsorption system; the method described above where the feed stream from a steam methane reformer and the tail gas from a plasma process are compressed prior to mixing; the method described above including compressing a feed stream of hydrogen rich gas and adding it to the tail gas from a plasma process prior to passing the tail gas from a plasma process into the pressure swing adsorption system; the method described above where the hydrogen rich gas is generated from a steam reforming process; the method described above where the tail gas is from a carbon black generating process: the method described above where at least a portion of the pressure swing adsorption tail gas is used in the carbon black generating process; the method described above where the feed stream flows at 70.000 million standard cubic feet per day (MMSCFD), the feed stream hydrogen is at 97.49% purity, the flow is at 10 pounds per square inch gauge (psig), 100° F., 973.1 million British thermal units (MMBTU) higher heating value (HHV/hour), and 824.4 MMBTU lower heating value (LHV/hour), the feed stream compressor is at 2×7000 NHP, the purified hydrogen is flowed into the hydrogen product compressor at 350 psig at 110° F. and compressed at 4,500 NHP and the pressure swing adsorption tail gas is flowed into the PSA tail gas compressor at 5 psig at 90° F. at 1,250 NHP, the total hydrogen recovery out of the process is 89.5%, the purified hydrogen product is 70.000 MMSCFD of hydrogen at 100% purity, 900 psig, 100° F., 827.0 MMBTU (HHV/hour) and 698.4 MMBTU (LHV/hour), and the fuel produced is 8.920 MMSCFD of fuel at 50 psig, 100° F., 146.6 MMBTU (HHV/hour) and 127.9 MMBTU (LHV/hour); the method described above where the tail gas has a flowrate of 70 MMSCFD, a pressure of 10 psig, a temperature of 100° F., a molecular weight of 2.53 grams/mole, 97.49 mol % hydrogen, 0.20 mol % nitrogen, 1.00 mol % carbon monoxide, 1.10 mol % methane, 0.14 mol % acetylene, 0.07 mol % HCN, and 0.00 mol % water.

A method of generating and recapturing electricity from a combined cycle power plant is also described including flowing natural gas into a plasma process and hydrogen generating plant, flowing the hydrogen produced into a combined cycle power plant, flowing natural gas into the combined cycle power plant, resulting in the production of electricity which is partially flowed into a power grid, and partially flowed back into the plasma process plant, overall reducing the net air emission from the combined cycle power plant.

Additional embodiments include: the method described above where the plasma process is a carbon black generating process; the method described above where 1750 BTU/hour of natural gas flows into the carbon black generating plant , has a molecular weight of 19, is flowing at 34.5 tons per hour, the carbon black generating plant has an electrical efficiency of 7 megawatts per hour per ton (MW/hr/ton), carbon black production capacity of 200,000 tons/year or 25.0 tons/hour, generates a hydrogen rich tail gas at 1038 MMBTU/hour, 9.5 tons/hr., and 243.7 MMBTU/hour of steam, the combined cycle power plant has a heat rate of 6500 BTU/kilowatt hour using the hydrogen rich tail gas, and 8500 BTU/kilowatt hour using steam , producing 1157.6 megawatts of electricity, 982.6 MW of which is flowed into the grid and 175.0 MW, 159.7 MW from hydrogen, 28.7 MW from steam, and 13.4 MW excess, of which is flowed back into the carbon black generating plant, and where natural gas is also flowed into the combined cycle power plant at 6300 MMBTU/hour.

A method of recapturing electricity generated from a simple cycle power plant is also described including flowing natural gas into a plasma process and hydrogen generating plant, flowing the hydrogen produced into a simple cycle power plant, flowing natural gas and nitrogen dilution gas into the single cycle power plant, resulting in the production of electricity which is flowed back into the plasma process plant, overall reducing the net air emission from the simple cycle power plant.

Additional embodiments include: the method described above where the plasma process is a carbon black generating process; the method described above where 1750 BTU/hour of natural gas flows into the carbon black generating plant , the carbon black generating plant has an electrical efficiency of 7 megawatts per hour per ton (MW/hr/ton), feedstock efficiency 70 MMBTU/ton, carbon black production capacity of 200,000 tons/year and 25.0 tons/hour, generates hydrogen at 1050.0 MMBTU/hour, 9.5 tons/hr., the hydrogen is flowed into a simple cycle power plant with a heat rate fuel 8500 BTU/KWh, producing 175.0 MW of electricity , 123.5 from hydrogen, 51.5 from natural gas, which is flowed back into the carbon black generating plant; the method described above where natural gas with the following properties—435.7 MMBTU/hour, 8631 kilograms per hour (Kg/hr), and 10,788 Nm³/hr , and a 46,822 Nm³/hr nitrogen dilution are also flowed into the simple cycle power plant.

A method of generating and recapturing electricity from a steam power plant is also described including inputting electricity and natural gas into a plasma process carbon black, air, and hydrogen generating plant, flowing the air and hydrogen produced into a steam generating boiler, flowing the steam generated into a steam power plant, resulting in the production of electricity which is flowed back into the plasma process plant, or to the electricity grid, overall reducing the net air emission from the steam power plant.

Additional embodiments include: the method described above where a reduction in the consumption of fossil fuels and associated air emissions is realized at the steam power plant; the method described above where the plasma process is a carbon black generating process; the method described above where the natural gas is flowed at 34.5 tons per hour, 1,750.0 MMBTU/hour into a carbon black generating plant with an electrical efficiency of 7 MW/hr./ton, feedstock efficiency of 70 MMBTU/ton , carbon black production capacity of 200,000 tons/year and 25.0 tons/hour, which generates carbon black, and hydrogen at 9.5 tons/hr., 1038 MMBTU/hour, and air at 368 tons/hr. at 800° C., 287 MMBTU/hour, the hydrogen and air are flowed into a boiler with a boiler efficiency of 0.85 which generates steam at 165 bar and 565° C. , 1,126.13 MMBTU/hour, which is flowed into a coal fired electricity generating steam power plant with a steam cycle efficiency of 0.40, the electricity generated at 132 MW, which is flowed back into the carbon black generating plant or into the electricity grid, reducing the coal consumption at the coal fired electricity generating steam power plant by about 26 tons per hour (t/h).

These, and additional embodiments, will be apparent from the following descriptions.

### BRIEF DESCRIPTION OF THE DRAWINGS

FIG. 1 shows a schematic representation of typical tail gas integration system as described herein.

FIG. 2 shows a schematic representation of a typical combined cycle power plant integration system as described herein.

FIG. 3 shows a schematic representation of a typical simple cycle power plant integration system as described herein.

FIG. 4 shows a schematic representation of a typical steam power plant integration system as described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

Steam reforming of natural gas, or steam methane reforming (SMR), is a commonly used method for producing large volumes of hydrogen gas from natural gas. For example, in the presence of a metal-based catalyst, such as nickel, steam reacts with methane to yield carbon monoxide and hydrogen:

CH₄+H₂O→CO+3H₂

Additional hydrogen can also be produced from the carbon monoxide generated:

CO+H₂O→CO₂+H₂

Most of the millions of tons of hydrogen produced each year, e.g., in the United States, is produced by the steam reforming of natural gas.

Pressure swing adsorption (PSA) technology is typically used to separate gases in a mixture of gases, under pressure, according to the individual gases' molecular characteristics and affinity for specific adsorbent materials. Particular absorptive materials, such as zeolites, are typically used as molecular sieves, preferentially adsorbing a particular gas at high pressure. The process then “swings” to low pressure operation to desorb the particular adsorbed gas. PSA processes are commonly used to purify the hydrogen gas produced from the SMR process.

Although complex, simple cycle power plants are typically made up of gas turbines connected to an electrical generator. The gas turbines are typically made up of a gas compressor, fuel combustors and a gas expansion power turbine. In the gas turbine, air is compressed in the gas compressor, energy is added to the compressed air by burning liquid or gaseous fuel in the combustor, and the hot, compressed products of combustion are expanded through the gas turbine, which drives the compressor and an electric power generator. In a combined cycle power plant, the output from one system is combined with the overall input into a simple cycle steam power plant to increase its overall efficiency.

Both carbon black processing and the use of plasma in other processes and chemical processes can generate useful hydrogen as a by-product. The hydrogen produced can be used by other end users, e.g., like an oil refinery. Typically, the hydrogen needs to be purified and compressed before delivery to the end user. As described herein, many advantages can be realized by the direct integration of carbon black and other plasma processing into an existing process. For example, countless efficiencies can be realized as a result of more advantageous technical integration of such systems. Common equipment can be shared, such as a single PSA, a single hydrogen gas compressor, etc. Multiple energy or chemical streams can be integrated, for example, the hydrogen produced can be directly integrated with a combined cycle power plant and electricity can be received back.

U.S. Pat. No. 6,395,197 discloses a method for producing carbon black and hydrogen in a plasma system and then using the hydrogen to generate electricity in a fuel cell. It does not describe integration of a plasma carbon black and hydrogen plant with a PSA compressions system, a combined cycle power plant, a simply cycle power plant, or a steam power plant. In addition, the system described is of bench scale, and many of the challenges associated with integration of a carbon black and hydrogen plasma plant are a result of scale.

As described herein, one embodiment is to only have one stream of input into the PSA and compression system, the tail gas from the plasma process. A second embodiment include mixing the tail gas from the plasma process with a feed stream generated from a steam methane reformer and then passing the combined input stream into the PSA and compression system. A third embodiment includes compressing a feed stream that was generated via steam methane reforming and then mixing a compressed tail gas from the plasma process with the compressed feed stream. The combined stream then is injected into the PSA system. A fourth embodiment includes recycling a portion of the pressure swing adsorption tail gas back into the carbon black generating process.

### EXAMPLE 1

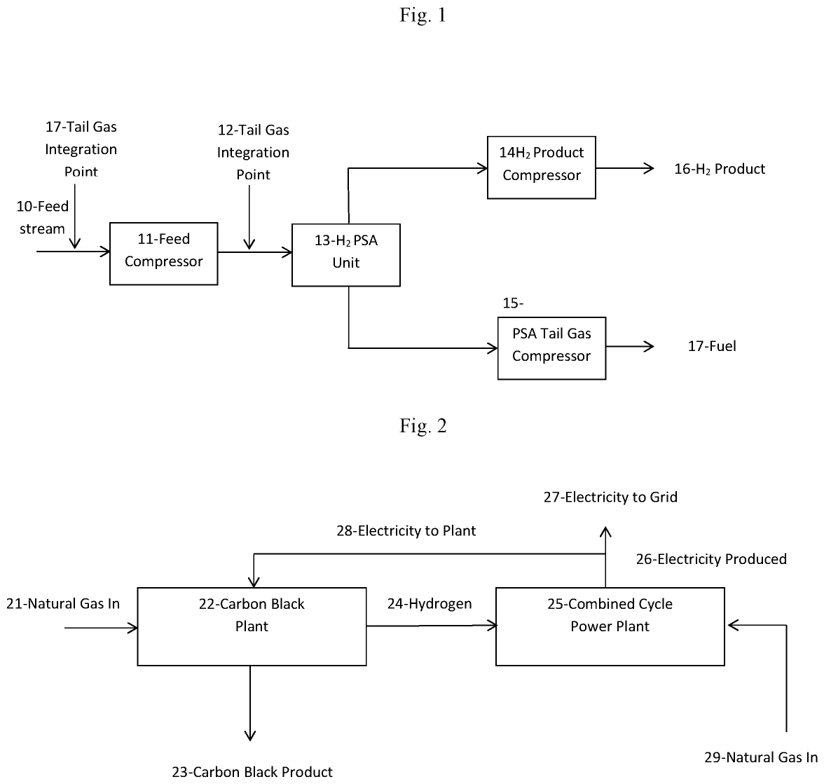

As shown schematically in FIG. 1, a feed stream (10) of 70.000 million standard cubic feet per day (MMSCFD), of hydrogen at 97.49% purity, 10 pounds per square inch gauge (psig), 100° F., 973.1 million British thermal units (MMBTU) higher heating value (HHV/hour), and 824.4 MMBTU lower heating value (LHV/hour) was flowed into a feed compressor (11) at 2×7000 NHP (Nominal Horse Power Flow rate=70 MMSCFD). At this point the tail gas (12) from a carbon black production plant is added to the compressed stream prior to it entering into the PSA unit (13). It should also be noted that it is not required that there be a feed stream and an additional tail gas stream. The feed stream can be just the tail gas from a plasma process stream and added at the front end of the system (17). The tail gas properties are shown in the Table below.

Table

| | | |
|---|---|---|
| Flowrate | MMSCFD | 70 |
| Pressure | Psig | 10 |
| Temperature | ° F. | 100 |
| Molecular | | |
| Weight | grams/mole | 2.53 |
| Hydrogen | Mol %: | 97.49% |
| Nitrogen | Mol %: | 0.20% |
| Carbon | | |
| Monoxide | Mol %: | 1.00% |
| Methane | Mol %: | 1.10% |
| Acetylene | Mol %: | 0.14% |
| HCN | Mol %: | 0.07% |
| Water | Mol %: | 0.00% |

The compressed tail gas stream is 70.000 MMSCFD of hydrogen at 97.49% purity, at 365 psig. The output of the PSA unit is 350 psig at 110° F. into the hydrogen product compressor (14) at 4,500 NHP and 5 psig at 90° F. into the PSA tail gas compressor (15) at 1,250 NHP. The hydrogen recovery out of the hydrogen PSA unit (13) is 89.5%. The output of the hydrogen product compressor (14) is hydrogen product with the following properties: 70.000 MMSCFD of hydrogen at 100% purity, 900 psig, 100° F., 827.0 MMBTU (HHV/hour) and 698.4 MMBTU (LHV/hour). The fuel recovery out of the PSA Tail Gas compressor (15) is fuel with the following properties: 8.920 MMSCFD of fuel at 50 psig, 100° F., 146.6 MMBTU (HHV/hour) and 127.9 MMBTU (LHV/hour).

### EXAMPLE 2

FIG. 2 shows schematically natural gas (21) with the following properties—1750.0 BTU/hour, 34.5 tons/hr.—going into the carbon black generating plant (22) with the following properties—electrical efficiency 7 megawatts per hour per ton (MW/hr/ton), feedstock efficiency 70 MMBTU/ton , carbon black production 200,000 tons/year and 25.00 tons/hour—generating carbon black (23) and hydrogen (24) with the following properties—1038 MMBTU/hour, and 9.5 tons per hour. The hydrogen is flowed into a combined cycle power plant (25) with the following properties—heat rate fuel 6500 BTU/kilowatt hour (KWh), heat rate steam 8500 BTU/KWh—producing 1157.6 megawatts (MW) of electricity, (26) 553 MW of which is flowed into a grid (27) and 175.0 MW (159.7 from hydrogen, 28.7 from steam, and 13.4 MW excess needed/produced) which is flowed back into the carbon black generating plant (22). Natural gas (29) with the following properties—6300 MMBTU/hour—is also flowed into the combined cycle power plant (25).

### EXAMPLE 3

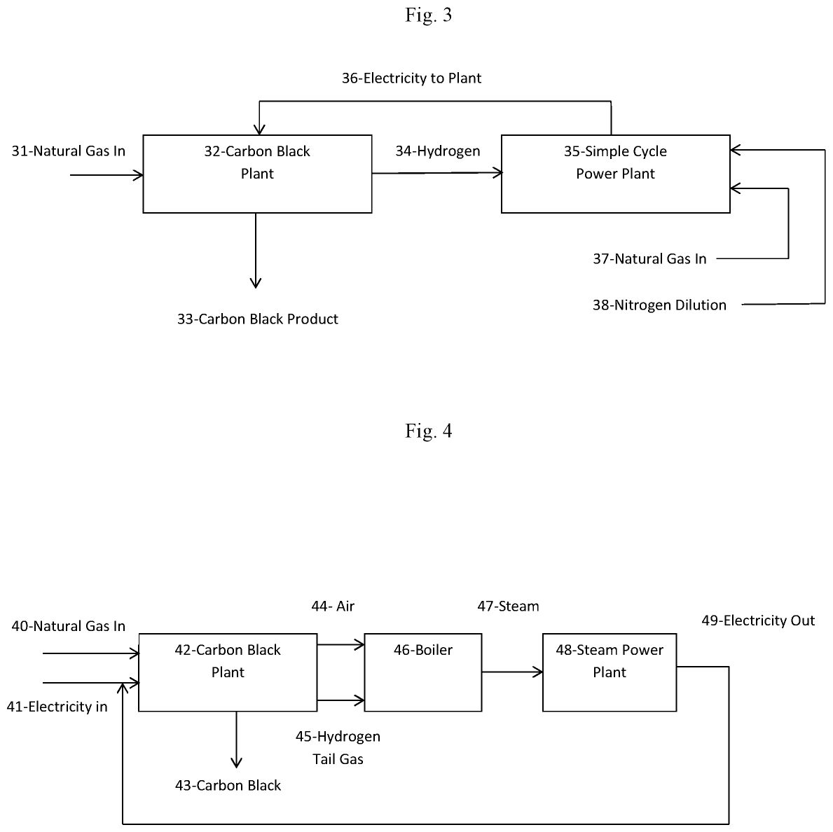

As shown schematically in FIG. 3, natural gas (31) with the following properties—1,750.0 MMBTU/hour, 34.5 tons per hour (tons/hr)—going into a carbon black generating plant (32) with the following properties—electrical efficiency 7 MW/hr/ton, feedstock efficiency 70 MMBTU/ton , carbon black production 200,000 tons/year and 25.00 tons/hour, with a carbon dioxide reduction of 322,787 tons per year, and a total feedstock efficiency of 87.5 MMBTU per ton—generating carbon black (33) and hydrogen (34) with the following properties—1050.0 MMBTU/hour, 9.5 tons/hr, 106,991 Nm³/hr (normal meter, i.e., cubic meter of gas at normal conditions, i.e. 0° C., and 1 atmosphere of pressure). The hydrogen is flowed into a simple cycle power plant (35) with the following properties—heat rate fuel 8500 BTU/KWh—producing 175.0 MW of electricity (36) (123.5 from hydrogen, 51.5 from natural gas) which is flowed back into the carbon black generating plant (32). Natural gas (37) with the following properties—435.7 MMBTU/hour, 8631 kilograms per hour (Kg/hr), and 10,788 Nm³/hr—and a nitrogen dilution (38) with the following properties—46,822 Nm³/hr—is also flowed into the simple cycle power plant (25).

### EXAMPLE 4

As shown schematically in FIG. 4, natural gas (41) with the following properties—1,750.0 MMBTU/hour, 513 molecular weight (grams/mole), 34.5 tons per hour (tons/hr)—is flowed into a carbon black generating plant (42) with the following properties—electrical efficiency 7 MW/hr/ton, feedstock efficiency 70 MMBTU/ton , carbon black production 200,000 tons/year and 25.00 tons/hour—generating carbon black (43) and hydrogen (45) with the following properties—1038 MMBTU/hour, 9.5 tons/hr., and air (44) with the following properties—287 MMBTU/hour, 84 molecular weight, at 800° C. The hydrogen and air are flowed into a boiler (46) with a boiler efficiency of 0.85 which generates steam (47) with the following properties—1,126.13 MMBTU/hour, at 165 bar and 565° C. which is flowed into a conventional electricity generating steam power plant (48) with a steam cycle efficiency of 0.40. The electricity generated (49) having the following properties—450 MMBTU/hour and 132 MW condensing—is flowed back into the carbon black generating plant (42). The conventional boiler and steam power plant could be a new plant located at the carbon black generating facility, or it could be an existing coal, oil, or gas fired power plant. In the case of an existing fossil fueled plant a significant reduction is the combustion of hydrocarbons, and the associated emissions of toxic and non-toxic air pollutants is also realized. The use of a conventional backpressure steam turbine integrated with an industrial steam process can also be used.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of producing a hydrogen gas, comprising: passing a tail gas comprising the hydrogen gas from a carbon black generating process into a pressure swing adsorption system, thereby obtaining a processed hydrogen gas and a pressure swing adsorption tail gas, separating the processed hydrogen gas from the pressure swing adsorption tail gas, and compressing the processed hydrogen gas and pressure swing adsorption tail gas.

2. The method of claim 1, including mixing the tail gas from a carbon black generating process with a feed stream from a steam methane reformer prior to passing the mixed tail gas into the pressure swing adsorption system.

3. The method of claim 2, wherein the feed stream from a steam methane reformer and the tail gas from a carbon black generating process are compressed prior to mixing.

4. The method of claim including compressing a feed stream of hydrogen rich gas and adding it to the tail gas from a carbon black generating process prior to passing the tail gas from the carbon black generating process into the pressure swing adsorption system.

5. The method of claim 4, wherein the hydrogen rich gas is generated from a steam reforming process.

6. (canceled)

7. The method of claim 1, wherein at least a portion of the pressure swing adsorption tail gas is reused in the carbon black generating process.

8. The method of claim 1 wherein the tail gas flows at 70.000 million standard cubic feet per day (MMSCFD), the tail gas comprises hydrogen at 97.49% purity, the tail gas is at 10 pounds per square inch gauge (psig), 100° F., 973.1 million British thermal units (MMBTU) higher heating value (HHV/hour), and 824.4 MMBTU lower heating value (LHV/hour), a feed stream compressor operates at 2×7000 NHP, the processed hydrogen gas is flowed into a hydrogen product compressor at 350 psig at 110° F. and compressed at 4,500 NHP and the pressure swing adsorption tail gas is flowed into a pressure swing adsorption tail gas compressor at 5 psig at 90° F. at 1,250 NHP, the total hydrogen recovery out of the process is 89.5%, the processed hydrogen product is 70.000 MMSCFD of hydrogen at 100% purity, 900 psig, 100° F., 827.0 MMBTU (HHV/hour) and 698.4 MMBTU (LHV/hour), and 8.920 MMSCFD of fuel is produced at 50 psig, 100° F., 146.6 MMBTU (HHV/hour) and 127.9 MMBTU (LHV/hour).

9. The method of claim 1, wherein the tail gas has a flowrate of 70 MMSCFD, a pressure of 10 psig, a temperature of 100° F., a molecular weight of 2.53 grams/mole, 97.49 mol % hydrogen, 0.20 mol % nitrogen, 1.00 mol % carbon monoxide, 1.10 mol % methane, 0.14 mol % acetylene, 0.07 mol % HCN, and 0.00 mol % water.

10.-20. (canceled)

21. The method of claim 1, wherein at least a portion of the pressure swing adsorption tail gas is used as fuel.
